(19) United States
(12) Patent Application Publication
(10) Pub. No.: US 2018/0030365 A1
(43) Pub. Date: Feb. 1, 2018

(54) SOLID LUBRICANT FILLED STRUCTURAL MATRIX

(71) Applicant: UNITED TECHNOLOGIES CORPORATION, Farmington, CT (US)

(72) Inventors: Chris Vargas, West Hartford, CT (US); Jeremy K. Paskind, Glastonbury, CT (US)

(73) Assignee: UNITED TECHNOLOGIES CORPORATION, Farmington, CT (US)

(21) Appl. No.: 15/728,904

(22) Filed: Oct. 10, 2017

Related U.S. Application Data
(62) Division of application No. 14/683,419, filed on Apr. 10, 2015.

(51) Int. Cl. C10M 103/00; B22F 3/105; B22F 3/26; C23C 4/12

(52) U.S. Cl. CPC C10M 103/00; C23C 4/12; B22F 3/1055; B22F 3/26; B33Y 10/00; Y02P 10/295; B33Y 80/00; B22F 2999/00

(57) ABSTRACT

A coating including a structural matrix having a porosity and a solid lubricant that at least partially fills the porosity.

### BACKGROUND

The present disclosure relates to high temperature, low friction composites, more particularly, to a solid lubricant filled structural matrix.

Coatings for use with low friction interfaces are typically required to have heat resistance, thermal shock resistance, oxidation resistance, and wear resistance. Coating compositions vary depending on the specific applications, e.g., seals for gas turbine engines, sizing equipment, aircraft engine parts, forming tools, glass fiber processing parts, firearm parts, etc. The compositions also vary depending on the function of the component, i.e., locking, ejection, sliding, rolling, rotating, impacting, bearing, etc.

Furthermore, coating compositions vary depending on the expected usage temperatures since, as temperature increases, the coefficient of friction (COF) increases for most materials. For example, the COF of a nickel alloy about 0.23 at room temperature, but is about 0.35 at 1000 F (538 C), and about 0.72 at 1200 F (649 C). This increase of COF with an increase temperature becomes a design consideration for parts operating at elevated temperatures.

Currently, relatively durable high temperature (1500 F and greater) low friction surface treatments are relatively difficult to manufacture. While hexagonal boron nitride (h-BN) can be applied to a substrate, this is merely a painting of the surface and the h-BN is readily worn away.

### SUMMARY

A coating according to one disclosed non-limiting embodiment of the present disclosure can include a structural matrix having porosity and a solid lubricant that at least partially fills said porosity.

A further embodiment of the present disclosure may include, wherein said structural matrix is reticulated.

A further embodiment of any of the foregoing embodiments of the present disclosure may include, wherein said porosity is between about 8%-40% open.

A further embodiment of any of the foregoing embodiments of the present disclosure may include, wherein said porosity is at least about 15% open.

A further embodiment of any of the foregoing embodiments of the present disclosure may include, wherein said structural matrix is manufactured of a nickel alloy.

A further embodiment of any of the foregoing embodiments of the present disclosure may include, wherein said structural matrix is about 0.03 inches thick.

A further embodiment of any of the foregoing embodiments of the present disclosure may include, wherein said structural matrix is manufactured of a cobalt alloy.

A further embodiment of any of the foregoing embodiments of the present disclosure may include, wherein said structural matrix is about 0.03 inches thick.

A further embodiment of any of the foregoing embodiments of the present disclosure may include, wherein said structural matrix is thermal sprayed.

A further embodiment of any of the foregoing embodiments of the present disclosure may include, wherein said structural matrix is between about 0.003-0.01 inches thick.

A further embodiment of any of the foregoing embodiments of the present disclosure may include, wherein said solid lubricant is mechanically retained within said structural matrix.

A further embodiment of any of the foregoing embodiments of the present disclosure may include, wherein said solid lubricant includes at least one of h-BN, CuO, ZnO, MgO, MnO2, and B2O3.

A further embodiment of any of the foregoing embodiments of the present disclosure may include, wherein said solid lubricant is vacuum impregnated into said structural matrix.

A method to manufacture a coating according to another disclosed non-limiting embodiment of the present disclosure can include applying a structural matrix having porosity to a substrate and at least partially filling the porosity with a solid lubricant.

A further embodiment of any of the foregoing embodiments of the present disclosure may include, wherein the applying includes thermal spraying.

A further embodiment of any of the foregoing embodiments of the present disclosure may include, wherein the applying includes additive manufacturing.

A further embodiment of any of the foregoing embodiments of the present disclosure may include, wherein the at least partially filling includes vacuum impregnation.

A further embodiment of any of the foregoing embodiments of the present disclosure may include, wherein the at least partially filling includes forming a liquid suspension with the solid lubricant.

A further embodiment of any of the foregoing embodiments of the present disclosure may include, applying a vacuum such that air in the pores is evacuated and replaced with the liquid suspension.

A further embodiment of any of the foregoing embodiments of the present disclosure may include, wherein the at least partially filling includes adding a binder to the solid lubricant.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic cross-sectional view of a coating according to one disclosed non-limiting embodiment;

FIG. 2 is an expanded top view of the coating; and

FIG. 3 is a block diagram of a method to manufacture the coating.

### DETAILED DESCRIPTION

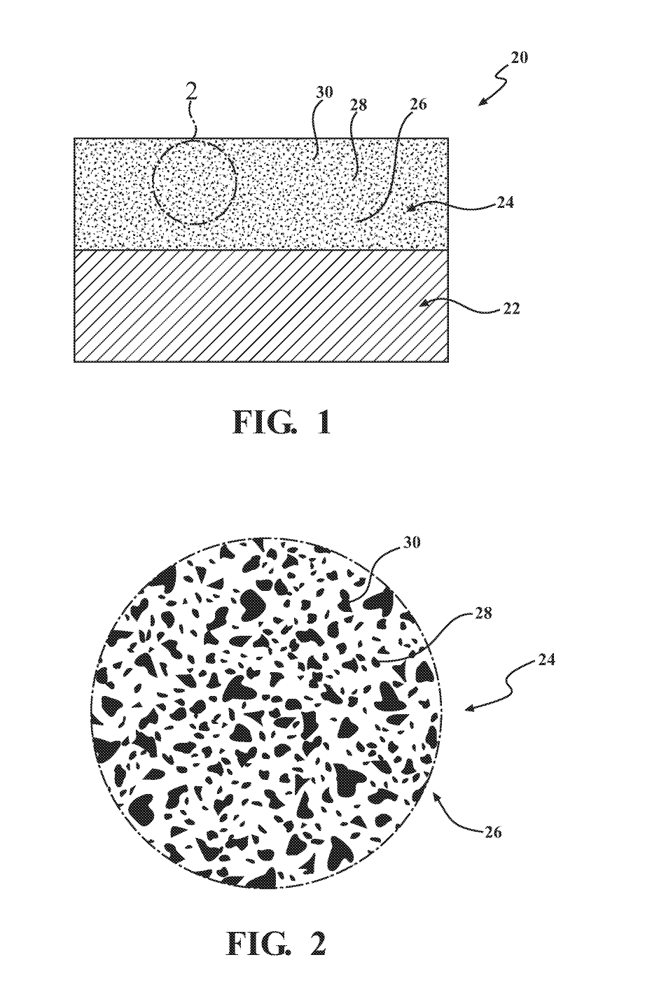

FIG. 1 schematically illustrates a representative cross-section of a component 20 including a substrate 22 and a coating 24 applied thereto. It should be appreciated that the component can be any component that requires a low friction interface to operate at elevated temperatures. Such components may be particularly applicable to gas turbine engine environments. Some example components include, but are not limited to, halo seals, and active clearance control systems in the gas turbine engine environment.

The coating 24 includes a structural matrix 26 having a porosity 28 formed therein and a solid lubricant 30 that at least partially fills the porosity. The structural matrix 26 essentially traps the solid lubricant 30 therein and is thus not readily worn away to form a high temperature low friction composite.

The structural matrix 26 is a porous body with open and connected porosity 28, often referred to as reticulated. The structural matrix 26 provides the mechanical structure to hold the solid lubricant 30 in place. The structural matrix 26 can, for example, be manufactured of a metal, ceramic, or combination thereof. Examples of metallic structural matrices include, but are not limited to nickel alloys such as Waspaloy, Haynes 282, C-263, Hastelloy X, IN625, etc. and cobalt alloys such as Stellite 6B, Stellite 31, etc. Composite structural matrix examples include, but are not limited to WC—Co, CrC—NiAl, etc.

The porosity 28, in one example, may be between about 8%-40% open (FIG. 2). That is, the porosity 28 is an open cell arrangement in which the structural matrix 26 forms a three-dimensional net that readily capturers the solid lubricant 30.

Once the structural matrix 26 is formed, the porosity 28 is filled with the solid lubricant 30. The solid lubricant 30 may include, but not be limited to, h-BN, CuO, ZnO, MgO, MnO2 and B2O3.

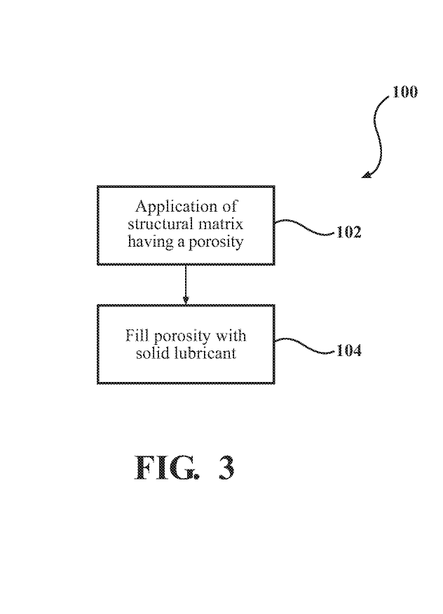

With reference to FIG. 3, a method 100 to manufacture the coating 24 according to one disclosed non-limiting embodiment initially includes application of the structural matrix 26 (step 102). The structural matrix 26 can be produced by various production methods that produce porous bodies, for example, as powder metal sintering, metal injection molding, additive manufacturing, ceramic sintering, and thermal spray coatings. In one embodiment, the structural matrix 26 is about 0.03 inches thick. In another embodiment, the structural matrix 26 such as tungsten carbide, cobalt, Chromium Carbide, or Nickel alloy (NiCr) composite is thermal sprayed such as via plasma, flame, HVOF, cold spray, etc., and is between about 0.003-0.01 inches thick. Alternatively still, the structural matrix 26 can be formed in-situ on the substrate 22 by additive manufacturing such as via Direct Metal Laster Sintering, laser powder deposition, electron beam deposition, etc.

Next, the porosity 28 is filled with the solid lubricant 30 (step 104). In one embodiment, the a liquid suspension is formed with the solid lubricant 30 and the structural matrix 26 is immersed in the liquid suspension under a vacuum such that air in the pores is evacuated and replaced with the liquid suspension. The suspension is wicked into the porosity 28 via capillary action. Then, the liquid is evaporated such that the solid lubricant 30 remains trapped within the pores. The solid lubricant 30 is of granularity to facilitate entry into the pores, yet is large enough that the solid lubricant 30 remains mechanically trapped therein once the suspension is evaporated to complete the high temperature low friction composite.

In another embodiment, a binder, such as a soluble silicate glass binder, is combined with the solid lubricant 30 then applied as above or essentially as a paste that is mechanically forced into the porosity via vacuum impregnation, or combinations thereof. Then, once the silicate glass binder dries, and the liquid is evaporated, the solid lubricant 30 and binder remain mechanically trapped in the structural matrix 26 completing the high temperature low friction composite. That is, the binder is agglomerated to increase bonding strength between the structural matrix 26 and the solid lubricant 30.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to normal operational attitude and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

1-13. (canceled)

14. A method to manufacture a coating, comprising:
(i) applying a structural matrix having a porous body with open and connected porosity to a substrate;
(ii) combining a soluble silicate glass binder with a solid lubricant; and
(iii) applying the soluble silicate glass binder with the solid lubricant into the porosity via vacuum impregnation, wherein the structural matrix provides the mechanical structure to hold the soluble silicate glass binder and solid lubricant in place.

15. The method as recited in claim 14, wherein the applying includes thermal spraying.

16. The method as recited in claim 14, wherein the applying includes additive manufacturing.

17. (canceled)

18. The method as recited in claim 14, further comprising forming a liquid suspension with the solid lubricant.

19. The method as recited in claim 18, further comprising applying a vacuum such that air in the pores is evacuated and replaced with the liquid suspension.

20. The method as recited in claim 19, further comprising adding a binder to the solid lubricant.

21. The method as recited in claim 14, wherein the applying includes thermal spraying at least one of a tungsten carbide, cobalt, Chromium Carbide, or Nickel alloy (NiCr) composite.

22. The method as recited in claim 14, wherein the applying includes applying the structural matrix to be between about 0.003-0.01 inches thick.

23. The method as recited in claim 14, wherein applying the soluble silicate glass binder with solid lubricant includes wicking the suspension into the porosity via capillary action.

24. The method as recited in claim 23, wherein the liquid is evaporated such that the solid lubricant remains trapped within the pores.

25. The method as recited in claim 24, wherein the solid lubricant is of a granularity to facilitate entry into the pores, yet is large enough that the solid lubricant remains mechanically trapped therein once the suspension is evaporated completing the high temperature low friction composite.

26. A method to manufacture a coating, comprising:
(i) applying a structural matrix having a porous body with open and connected porosity to a substrate;
(ii) combining a soluble silicate glass binder with a solid lubricant; and
(iii) applying the soluble silicate glass binder with the solid lubricant into the porosity, wherein the structural matrix provides the mechanical structure to hold the soluble silicate glass binder and solid lubricant in place.

27. The method as recited in claim 26, wherein the at least partially filling includes vacuum impregnation.
